(19) United States
(12) Patent Application Publication
(10) Pub. No.: US 2005/0242546 A1
(43) Pub. Date: Nov. 3, 2005

(54) King pin lock

(76) Inventor: Mario Plarre Paquet, Saint-Charles sur Richelleu (CA)

Correspondence Address: Louis Tessler, PO Box 54029, Mount-Royal, QC, H3P 3H4, CA

(21) Appl. No.: 11/117,501

(22) Filed: Apr. 29, 2005

Related U.S. Application Data
(60) Provisional application No. 60/566,096, filed on Apr. 29, 2004.

(51) Int. Cl. B62D 53/06

(52) U.S. Cl. 280/507

(57) ABSTRACT

A king pin lock mountable over a king pin of a trailer so as to selectively prevent engagement of the king pin, the king pin being provided with an annular recess defining a pair of locking shoulders. The king pin lock includes a king pin lock housing defining a housing upper surface, an opposed housing bottom surface and a housing peripheral surface extending therebetween. The king pin lock housing is provided with a king pin receiving recess for slidably and substantially fittingly receiving the king pin. The king pin lock also includes a housing locking assembly for releasably locking the king pin in the king pin receiving aperture. The housing locking assembly includes a locking component for selectively lockingly engaging the king pin annular recess so as to abut against the king pin lower shoulder and prevent retraction of the king pin from the king pin receiving aperture. An access limiting assembly is provided for selectively limiting access to the locking component so as to prevent illegal retraction of the locking component from the king pin recess.

### FIELD OF THE INVENTION

The present Invention relates to the general field of theft prevention devices and is particularly concerned with a king pin lock.

### BACKGROUND OF THE INVENTION

Tractor-trailer combinations are commonly used for the transportation of freight. The conventional tractor-trailer hitch or coupling structure has been standardised so that practically any tractor can be coupled to any trailer. Conventional tractor-trailer trucking rigs typically include a cylindrical king pin extending downwardly from the bottom surface of the trailer adjacent a front edge thereof. The king pin is provided with an exterior circumferential groove.

The conventional tractor-trailer trucking rig also includes a complementary skid plate receptacle or fifth wheel mounted to the rear of the tractor. The fifth wheel is provided with a skid plate having an opening in which the king pin of the trailer is carried.

The annular groove of the king pin is typically engaged by movable jaws of the fifth wheel. The jaws of the fifth wheel engage the annular groove on the king pin of the trailer to pivotally secure the trailer to the tractor. When the king pin is locked into engagement with the fifth wheel, the trailer can be hauled by the tractor.

There are many occasions wherein trailer are uncoupled from tractors and are left unattended. Examples of such situations include during loading and unloading of the trailer, for storing trailers when they are not in use, or for using tractors independently of the trailers. In such instances, an unauthorized person with a tractor having a complementary skid plate for the trailer king pin may simply couple to the trailer, connect the air hoses to release the trailer brakes and haul the trailer away.

Hence, the theft of unattended trailers has been a large problem because it is a simple matter to attach a tractor and merely drive away. The annual lost sustained by shippers and insurance companies due to highjacking of trailers Is indeed very substantial.

Various types of devices for preventing theft of trailers are known in the prior art. For example, to prevent unauthorised use of trailers having a coupling pin so-called king pin locks have been devised. Such king pin locks are typically secured to the trailer coupling pin so as to prevent coupling of the trailer coupling pin to a complementary receptacle or fifth wheel on a tractor. Such king pin locks typically include a locking mechanism by means of which the king pin lock is locked to the trailer coupling pin.

Although somewhat useful, most prior art king pin locks suffer from numerous disadvantages and, hence, are not entirely satisfactory.

For example, some prior art king pin locks are simply not strong enough to resist the heavy blow from a sledge or the like without being broken and thus rendered useless. Other prior art king pin locks, while being able to sustain a relatively heavy blow from a sledge in normal temperature conditions, may be unable to resist such a blow when subjected to temperature stresses. Furthermore, some prior art king pin locks are unable to resist to other types of stresses such as chemical stresses or combinations of thermal and chemical stresses.

In prior art king pin locks using a lock cylinder, the latter is exposed so that it could be easily tampered with. For example, the lock cylinder, That part of the lock of the king pin lock which receives a key and is selectively movable between locked and unlocked configurations thereof, could be engaged by drilling into it and connecting a pulling device for forcibly retracting the lock cylinder from the king pin lock rendering the latter useless.

Some prior art king pin locks require relatively numerous costly parts or expenses to manufacture. Some prior art king pin locks also contain parts which are particularly susceptible to wear and/or to being rendered inefficient In conventional operational conditions. Still furthermore, some prior art king pin locks are difficult to install and remove by the user.

Accordingly, there exists a need for an improved king pin lock. It is a general object of the present invention to provide such an improved king pin lock.

Advantages of the present invention include that the proposed king pin lock is lockable to the coupling pin of a vehicle such as a trailer for preventing unauthorised used of the vehicle.

The proposed king pin lock is designed so as to be particularly resistant to unauthorised attempts at removal thereof from the coupling pin of the vehicle. For example, the proposed king pin lock is designed so as to be able to withstand relatively large stresses such as: mechanical stresses by heavy blows from a sledge, a tractor or the like, thermal stresses by welding torches, freon, nitrogen or the like, mechanical stresses by acids or the like, or a combination of such stresses.

The proposed king pin lock is also designed so as to protect the lock cylinder from being tampered with, for example, by drilling into it and connecting a pulling device to it for forcibly retracting it.

The proposed king pin lock is also designed so as to reduce the risks of having a tractor attached thereto so as to pull the trailer having the king pin lock mounted on the king pin.

Yet, still furthermore, the proposed king pin lock is designed so as to be able to withstand normal operational conditions including the presence of surrounding oil, dust and the like with reduced risks of altering the functioning of the king pin lock.

Also, the proposed king pin lock is designed so as to be easily installable and removable by a user thereof on a conventional king pin of most conventional trailers through a set of quick and ergonomic steps without requiring special tooling or manual dexterity.

Still, furthermore, the proposed king pin lock is designed so as to be usable with conventional standard lock cylinders.

Also, the proposed king pin lock is designed so that the key for operating it may only be retracted from the locking mechanism when the king pin lock is in its locked configuration for reducing the risks of having the king pin lock held by the trailer coupling pin without being locked thereto. This prevents removal of the key from the lock cylinder except when the lock cylinder is in its locked condition, thereby providing a positive, visually detectable way to determine if the king pin lock is locked to the trailer or simply secured thereto. The king pin lock also includes a dead bolt-type mechanism so that it cannot be locked to a coupling pin without a key.

Yet, still furthermore, the proposed king pin lock is designed so as to be manufacturable using conventional parts and conventional forms of manufacturing so as to provide a king pin lock that will be economically feasible, long-lasting and relatively trouble-free in operation.

### BRIEF DESCRIPTION OF THE DRAWINGS

An embodiment of the present invention will now be disclosed, by way of example, In reference to the following drawings, in which:

FIG. 1, in a partial perspective view with sections taken out, illustrates a king pin lock in accordance with an embodiment of the present invention, operationally mounted over a king pin (not shown) of a conventional semi-trailer, the semi-trailer being shown in phantom lines;

FIG. 2, in a top perspective view, illustrates a king pin lock in accordance with an embodiment of the present invention;

FIG. 3, in a partial exploded view with sections taken out, illustrates some of the components of the king pin lock shown in FIG. 2;

FIG. 4, in a partial cross-sectional view with sections taken out, illustrates part of a king pin lock such as shown in FIG. 2 operationally mounted to a conventional king pin (shown in phantom lines), the king pin lock being shown in a locked configuration and with a conventional Allen key (only a portion of which is being shown in phantom lines) about to be used therewith;

FIG. 5, In an exploded view, illustrates part of the locking mechanism of the king pin lock shown in FIG. 2;

FIG. 6, in a front elevational view, illustrates part of the locking mechanism shown in FIG. 5 with its front cover plate removed and in a locked configuration;

FIG. 7, in front elevational view with sections taken out, illustrates the locking mechanism shown in FIG. 6 in an unlocked configuration;

FIG. 8, in a rear elevational view with sections taken out, illustrates the locking mechanism shown in FIGS. 6 and 7 with its rear cover plate removed and in a locked configuration;

FIG. 9, in a partial exploded view with sections out, illustrates some of the components of the locking mechanism shown in FIGS. 5 through 8.

### DETAILED DESCRIPTION

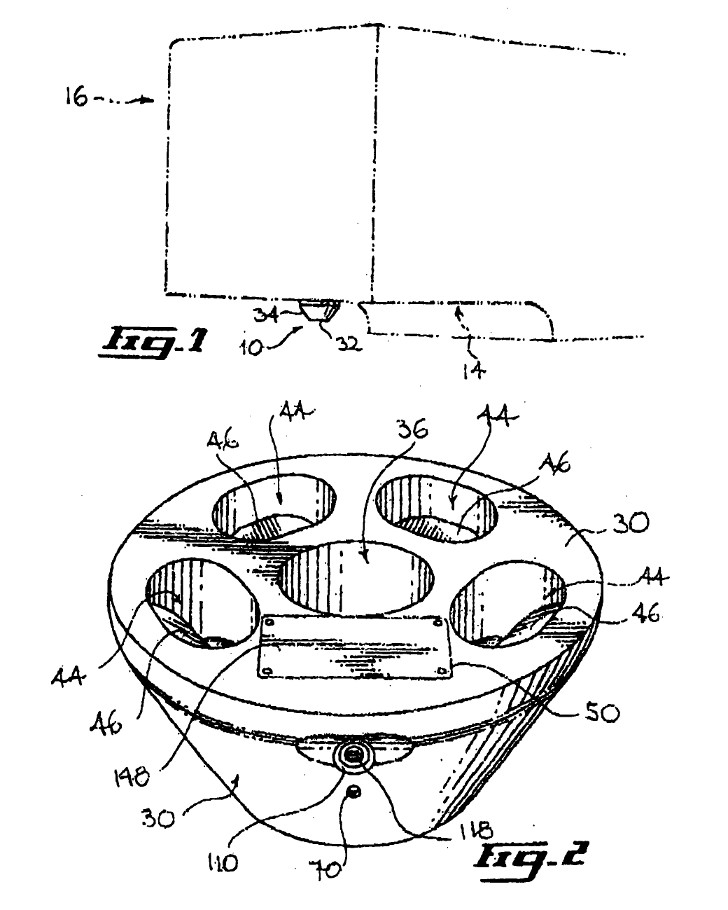

Referring to FIG. 1, there is shown a king pin lock in accordance with an embodiment of the present invention, generally designated by the reference numeral 10. The king pin lock is shown operationally mounted over a conventional king pin 12 (shown in FIG. 4) extending downwardly from an undersurface 14 of a conventional trailer or semi-trailer 16 adjacent a front end thereof. Typically, although by no means exclusively, the king pin 12 extends from a bearing pad of the trailer or semi-trailer 16.

The king pin lock 10 is intended to prevent engagement by an unauthorised tractor (not shown) of the king pin 12 so as to prevent the trailer 16 from being hitched to the unauthorised tractor and stolen. It should, however, be understood that the king pin lock 10 could be used in other contexts such as for preventing the theft of other types of vehicles or in other theft prevention setting without departing from the scope of the present invention.

The conventional king pin 12 typically has a substantially cylindrical configuration. As shown in FIG. 4, the conventional king pin 12 is provided with an annular recess 18 formed by a reduced diameter portion and an upper and lower full diameter portions 20, 22. The recess 18 hence defines ring-shaped upper and lower locking shoulders 24, 26.

The king pin lock 10 includes a king pin housing 28 typically defining a housing upper surface 30 for positioning substantially adjacent the trailer undersurface 14, an opposed housing bottom surface 32 and a housing peripheral surface 34 extending therebetween.

The king pin lock housing 28 is provided with a king pin receiving recess or aperture 36 for slidably and substantially fittingly receiving the king pin 18. Typically, the king pin receiving aperture 36 is a blind aperture (closed at the bottom) extending from the housing top surface 30.

The king pin lock 10 is also provided with a housing locking means for releasably locking the king pin 18 in the king pin receiving aperture 36. The overall configuration of the king pin lock housing 28 is such that when the latter is mounted to the king pin 18, the king pin 18 cannot be coupled to a complementary skid plate (not shown) of a tractor.

In the embodiment shown throughout the Figures, the king pin lock housing 28 has a downwardly tapering substantially frustro-conical configuration. It should, however, be understood that the king pin lock housing could have other suitable configurations without departing from the scope of the present invention.

Also, in the embodiment shown throughout the Figures, the housing peripheral surface 34 defines a substantially cylindrical peripheral surface sub-section 38 having a substantially constant diameter. The peripheral surface sub-section 38 is intended to facilitate both manufacturing of the king pin lock 10 and to facilitate handling thereof.

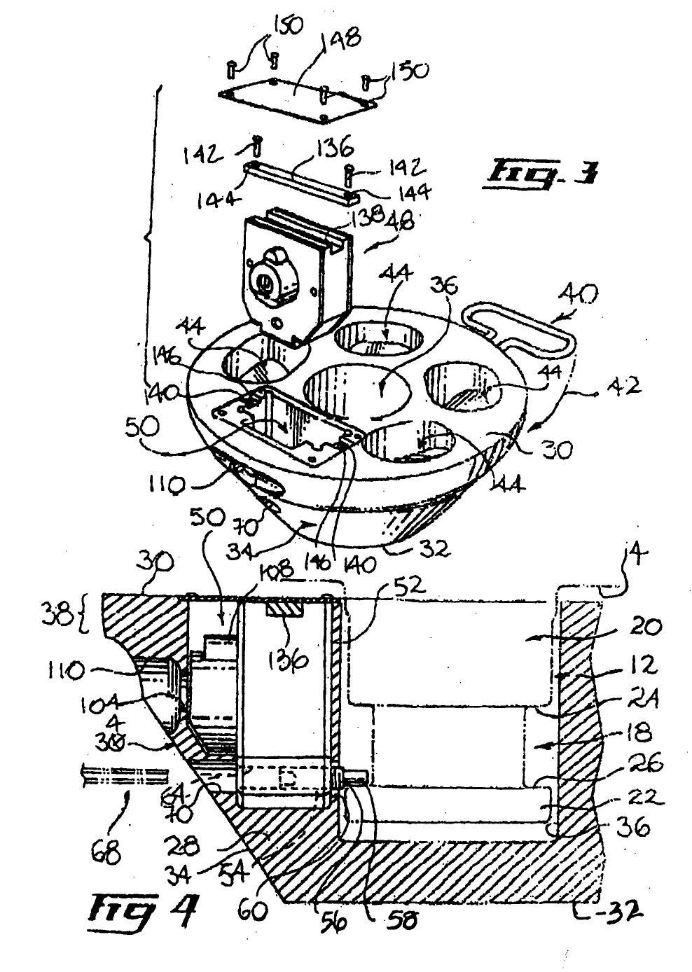

Optionally, the king pin lock 10 may also be provided with a housing handle 40 extending therefrom for further facilitating handling and transportation of the king pin lock 10. As shown by arrow 42 in FIG. 3, the housing handle 40 may optionally be of the pivotal type, pivotable between a handle extended configuration wherein it extends generally outwardly from the king pin lock housing 28 and a handle retracted configuration (not shown) wherein it lies in a generally parallel relationship relative to the housing peripheral surface 34.

Although the king pin lock 10 may be constructed of different materials and have different configurations and dimensions, the king pin lock housing 28 is typically made out of a substantially strong and stress-resistant material such as steel or the like. In a preferred embodiment of the invention, the king pin lock housing is made out of a steel alloy such as a heat-treated 366 steel alloy.

As illustrated more specifically in a FIGS. 2 and 3, the king pin lock housing 20 is typically further provided with at least one and preferably a set of auxiliary recesses or blind apertures 44 extending partially therethrough. Typically, the auxiliary apertures 44 are formed in the housing top surface 30 in a substantially circumferentially spaced relationship relative to each other.

Typically, the auxiliary apertures 44 have a substantially oval configuration and an inclined auxiliary aperture inner wall 46. It should, however, be understood that the auxiliary apertures 44 could have other suitable configurations, sizes and positions without departing from the scope of the present invention.

The auxiliary apertures 44 are intended to lower or lessen the overall weight or density of the king pin lock housing 28 without substantially reducing the resistance of the latter to mechanical or other stresses. Furthermore, the auxiliary apertures 44 are also intended to lessen the susceptibility of the king pin lock housing 28 to thermal stresses by lowering the thermal expansion and retraction of the king ping housing 28 when subjected to such thermal stresses.

The king pin lock 10 further includes a locking mechanism generally indicated by the reference numeral 48 for releasably locking the king pin 18 in the king pin receiving aperture 36.

As illustrated more specifically in FIGS. 3 and 4, the king pin lock housing 28 is provided with a locking mechanism recess 50 for protectively housing the locking mechanism 48. Typically, the locking mechanism recess 50 extends through the housing top surface 30 substantially adjacent to the king pin receiving recess 36. Typically, the locking mechanism recess 50 is separated from the king pin receiving recess 36 by a locking mechanism-to-king pin recess partition wall 52.

The locking mechanism 48 includes a locking component 54 for selectively lockingly engaging the king pin annular recess 18 so as to abut against the king pin lower shoulder 26 and prevent retraction of the king pin 12 from the king pin receiving aperture 36.

In the embodiments shown throughout the Figures, the locking component 54 includes a set-type screw component having a screw threaded segment 56 extending integrally into a screw abutment section 58. The screw abutment section 58 is adapted to be selectively extended and retracted into and out of engagement with the king pin annular recess 18 for selectively preventing and allowing retraction of the king pin 12 from the king pin receiving aperture 36.

Typically, the screw abutment segment 58 extends through a corresponding through aperture 60 formed in the locking mechanism-to-king pin recess partition wall 52 as illustrated din FIG. 4.

The locking component 54 is slidably inserted into a locking mechanism casing 62 for threadable engagement therewith. The locking mechanism casing 62 hence defines casing screw receiving aperture 64 extending therethrough. The casing screw receiving aperture 64 is provided with an internal thread adapted to threadably engage the threaded section 56 of the set screw 55.

The set screw 54 is typically provided with tool engaging means for allowing operational engagement of a tool therewith. In the embodiment shown throughout the Figures, the tool engaging means includes an Allen key receiving recess 66 for operationally receiving a segment of a conventional Allen key type tool 68 such as illustrated in FIG. 4. It should, however, be understood that the set screw component 54 could have other tool engaging means such as a conventional screw slot for receiving the distal tip of a conventional screwdriver or the like without departing from the scope of the present invention.

As shown in FIG. 4, the king pin lock housing 28 is further provided with a tool receiving aperture 70 extending partially therethrough for receiving an operational portion of the tool 68. Typically, the tool receiving aperture 70 extends through the housing peripheral surface 34.

One of the features of the present invention resides in the presence of an access limiting means for selectively limiting access to the locking component 54 so as to prevent illegal retraction of the locking component 54 from the king pin annular recess 18.

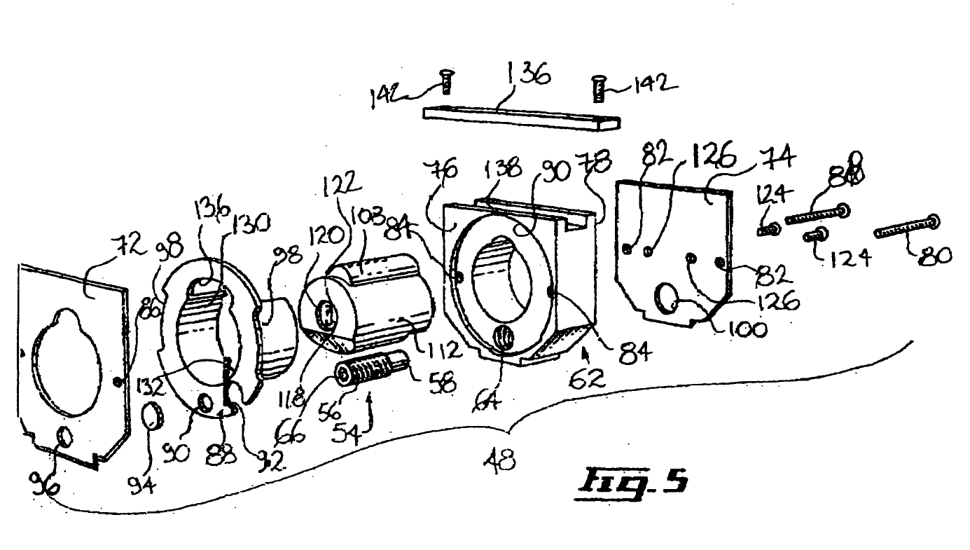

As illustrated more clearly in FIG. 5, the locking mechanism 48 also includes a locking mechanism front plate 72 and a locking mechanism rear plate 74 attachable to the locking mechanism housing 62 respectively against lock housing front and rear surfaces 76, 78 thereof. Typically, the locking mechanism front and rear plates 72, 74 are releasably attached to the locking mechanism housing 62 using conventional attachment means such as lock housing attachment screws 80 extending through corresponding lock housing screw apertures 82, 84 and 86 formed respectively in the locking mechanism rear plate 74, the locking mechanism housing 62 and the locking mechanism front plate 72.

The access limiting means typically includes an access limiting flange 88 mounted for selective rotation within a corresponding flange receiving recess 90 formed in the lock housing front surface 76.

The access limiting flange 88 is provided with a flange access aperture 90, a flange prevention aperture 92, both extending therethrough. The flange preventing aperture 48 is provided with flange guard disc 94 mounted therein for free rotation thereabout.

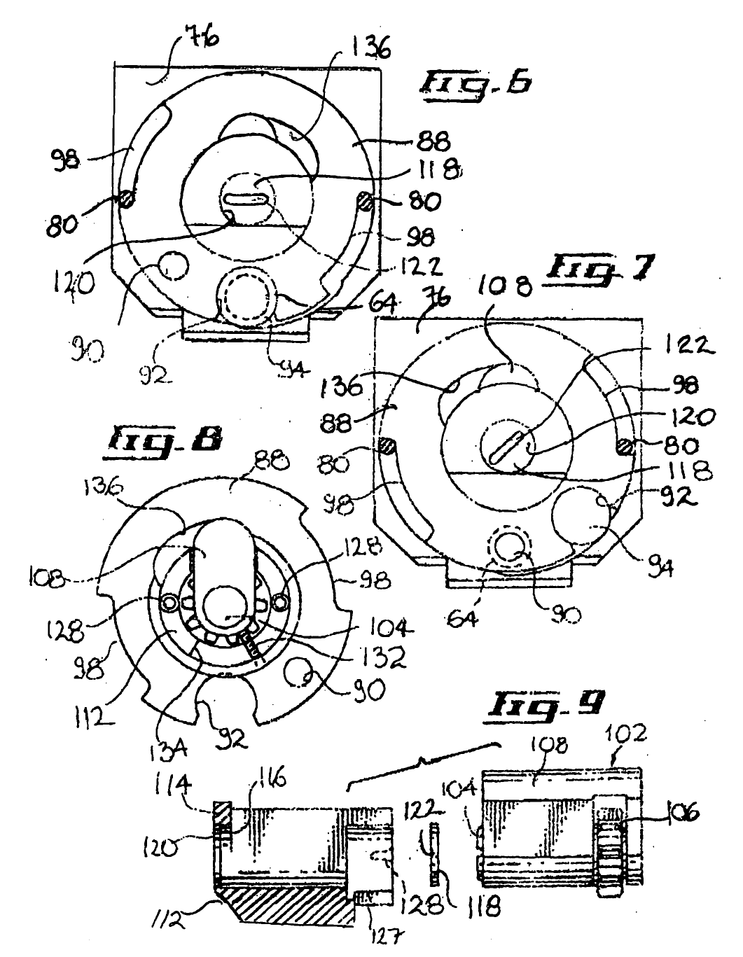

The lock housing front plate 78 is provided with a front plate access aperture 96 extending therethrough substantially in register with the housing screw receiving aperture 64. The locking mechanism 48 is still further provided with a flange rotating means for selectively rotating the access limiting flange 88 between flange access allowing configuration as shown in FIG. 7 and a flange access preventing configuration as shown in FIG. 6.

In the access allowing configuration shown in FIG. 7, the flange access aperture 90 is substantially in register with the front plate access aperture 96 so as to allow the tool 68 access to the tool receiving recess 66 of the locking component 54 for selectively moving the latter into and out of engagement with the king pin annular recess 18.

In the flange access preventing configuration shown in FIGS. 6 and 8, the flange guard disc 94 is substantially in register with the front plate access aperture 96, hence preventing access of the tool 68 to the locking component 54. Furthermore, since the flange guard disc 94 is mounted for free rotation within the flange preventing aperture 92, attempts at drilling and flange guard disc 94 only result in rotating the latter within the flange preventing aperture 92.

When lock casing attachment screws 80 are used and positioned such as illustrated through the drawings, the access limiting flange 88 is preferably further provided with peripheral flange tool receiving recesses 98 for preventing mechanical interference of the lock housing attachment screws 80 during rotation of the access limiting flange 88 between its access allowing and access preventing configurations.

The lock housing rear plate 74 is provided with a rear plate screw receiving aperture 100 for allowing threadable movement of the locking component 54 therethrough.

In the embodiments shown throughout the Figures, the flange rotating means includes a conventional key operated lock 102. The lock 102 typically has a key plug 104 protected by a lock casing 108 for rotating corresponding lock teeth 106.

As illustrated in FIG. 4, the king ping lock housing 28 is still further provided with a lock key aperture 110 for allowing access to the key plug 104. Typically, the lock key aperture 110 extends through the lock housing peripheral surface 34.

The lock casing 108 typically has a substantially ovaloid cross section containing the key plug 104 in its lower lobe and containing a mechanism for rotating the lock teeth 106 in its upper lobe.

As illustrated more specifically in FIGS. 5 and 9, the locking mechanism 48 also includes a lock shell 112 for at least partially protectively receiving at least part of the lock casing 108. The lock shell 112 is provided with key plug access limiting means for selectively limiting access of the key plug 104.

The shell 112 defines a shell front wall 114. The shell front wall 114 is provided with a shell access aperture 120 extending therethrough. The shell front wall 114 is also provided with a shell disc receiving recess 116 formed on the inner surface thereof substantially in register with the shell access aperture 120. The shell access limiting means includes a shell guard disc 118 rotatably mountable within the disc receiving recess 116 for free rotation therein. The shell guard disc 118 is large enough so that its edges overlap the edges of the shell front wall aperture 120 and the shell guard disc 118 is supported from behind by the front face of the key plug 104.

The shell guard disc 118 is hence rotatably mounted between remaining sections of the shell front wall 114 and the key plug 104 and the lock mechanism 102 is mounted in the lock shell 112. The shell guard disc 118 has a guard disc key slot 122 for allowing selective access to the key plug 104 by a corresponding conventional key.

The restricted key slot 122 in the shell guard disc 118 and its freely rotatable mounting are adapted to obstruct drilling so as to prevent tampering with the key plug 104.

The guard plates 94 and 118 are made of hardened steel or other hard and strong material which resist cutting and drilling so as to protect the lock mechanism 48 against various mechanical attacks.

The lock mechanism 102 is adapted to be secured to the shell 118 using conventional fastening means such as shell fastening screws 124 extending through corresponding shell screw apertures 126 and 128 formed respectively in the lock housing back plate 74 and the shell 112.

The access limiting flange 88 is provided with a flange coupling segment 130 having substantially the configuration of a truncated cylinder extending substantially perpendicularly therefrom. A lock-to-flange coupling pin 132 extends between the rotating portion of the lock 102 adjacent the lock teeth 106 and the flange coupling segment 130 as shown more specifically in FIGS. 5 and 8. Rotation of the lock teeth 106 and, hence, of the lock-to-flange coupling pin 132 through the use of a conventional key inserted into the key plug 104 hence results in rotation of the access limiting flange 88 so as to selectively allow and prevent access to the locking component 54.

The shell component 112 is provided with a pin receiving recess 134 for allowing interference free rotation of the lock-to-flange coupling pin 132. Similarly, the access limiting flange 88 is typically further provided with a lock receiving recess 136 for allowing an interference free rotation of the lock casing 108 relative to the access limiting flange 88.

As shown more specifically in FIGS. 3 through 5, the locking mechanism 48 is typically locked into the lock receiving recess 50 by a suitable lock retaining means. The lock retaining means includes a locking bar 136 (already used to designate another element) substantially fittingly inserted into corresponding bar receiving recesses 138, 140 provided respectively in the upper surface of the lock mechanism housing 62 and the king pin lock housing 28. Bar screws 142 extending through corresponding bar screw apertures 144, 146 are used to secure the locking bar 136 to the kin pin lock housing 28.

A cover plate 148 is typically secured over the locking mechanism 48 for protecting the latter against environmental elements such as oil, dust, and the like. The cover plate 148 is typically secured to the king pin lock housing 28 using suitable fastening means such as cover plate screws 150.

1. A king pin lock mountable over a king pin of a trailer so as to selectively prevent engagement of said king pin, said king pin being provided with an annular recess defining a pair of locking shoulders, said king pin lock comprising:
a king pin lock housing defining a housing upper surface, an opposed housing bottom surface and a housing peripheral surface extending therebetween; said king pin lock housing being provided with a king pin receiving recess for slidably and substantially fittingly receiving said king pin;
a housing locking means for releasably locking said king pin in said king pin receiving aperture; said housing locking means including a locking component for selectively lockingly engaging said king pin annular recess so as to abut against said king pin lower shoulder and prevent retraction of said king pin from said king pin receiving aperture;
an access limiting means for selectively limiting access to said locking component so as to prevent illegal retraction of said locking component from said king pin recess.
